(19) United States
(12) Patent Application Publication
(10) Pub. No.: US 2008/0250010 A1
(43) Pub. Date: Oct. 9, 2008

(54) Method and system for determining and pre-processing potential user queries related to content in a network

(75) Inventors: Priyang Rathod, Mountain View, CA (US); Mithun Sheshagiri, Berkeley, CA (US); Anugeetha Kunjithapatham, Sunnyvale, CA (US); Phuong Nguyen, San Jose, CA (US); Alan Messer, Los Gatos, CA (US)

Correspondence Address: Kenneth L. Sherman, Esq.;Myers Dawes Andras & Sherman, LLP, 11th Floor, 19900 MacArthur Blvd., Irvine, CA, 92612, US

(73) Assignee: Samsung Electronics Co., Ltd., Suwon City (KR)

(21) Appl. No.: 11/732,887

(22) Filed: Apr. 5, 2007

(51) Int. Cl. G06F 17/30

(52) U.S. Cl. 707/5

(57) ABSTRACT

A framework identifies data that a user would likely be interested to access, then extracts and stores such data for the user to efficiently use when desired. Thereby, the framework allows the user to access several types of information efficiently, without the user having to request the information.

### FIELD OF THE INVENTION

The present invention relates to processing queries in a network, and more particularly to a framework for determining and pre-processing potential user queries related to content stored in a network.

### BACKGROUND OF THE INVENTION

The number of networked devices in local networks is on the rise, and so is the amount of data stored on them. Examples of networked devices include consumer electronic (CE) devices in local area networks such as home networks. Typically, consumers store and access several types of content (e.g., audio, video, image, other data files, etc.) in different formats on/via their devices. In addition to accessing such content, consumers commonly access audio/video broadcast data streams via external sources such as live broadcast television, cable networks, the Internet, etc.

Likewise, the amount of information available via the Internet is continually on the rise. A significant amount of information on the Internet relates to at least some of the content stored on a home network.

Media players (e.g., Windows Media Player, Real player, etc.), extract metadata information from the Internet for content that is currently/previously played by a user (i.e., content of interest to the user). Typically, such media players maintain a standard set of metadata types that can be extracted and displayed to a user, and rely on specific websites to obtain the required metadata. However, the amount of information made available to the user is limited since such media players only communicate with fixed websites on the Internet. As a result, the user cannot access random information related to the content of interest. In other words, if information related to the content of interest is not among the standard metadata information available on the specific websites that the media player is pre-configured to access, then the user is not presented with such related information.

Desktop search applications such as Google Desktop Search and Copernic are extensions of Internet searches where users can search for content on their PCs. However, drawbacks of such search extensions include: (1) requiring users to form queries and to refine the queries in order to obtain desired results, (2) requiring computing resources that far exceed what CE devices provide for analyzing large volumes of search results, and (3) requiring input devices such as a keyboard to enter a significant amount of query text for searching.

Therefore, there is a need for a method and system that simplifies processing of potential user queries related to content stored in a network.

### BRIEF SUMMARY OF THE INVENTION

The present invention provides a framework that identifies data that a user would likely be interested to access, then extracts and stores such data for the user to efficiently use when desired. A method of searching for information related to content stored in a network includes determining one or more potential user queries for information related to the content stored in the network, and resolving the queries by searching available sources before actual user request for information related to the content stored in the network.

Thereby, the framework allows the user to access several types of information efficiently, without the user having to explicitly request the information. As such, the framework does not restrict the user to choose the type of information the user wishes to access from a limited list of metadata information.

In addition, in some embodiments, the framework enables users to use a CE device, such as a TV, for accessing information using a small number of keys without the need for a typical keyboard. Further, the framework allows the users to obtain information from an external network (e.g., the Internet) with minimum involvement in query construction. The framework suggests information based on query context to augment user experience of using CE devices with additional data. Accordingly, the power of the Internet is delivered to consumers that use CE devices in an efficient manner in terms of performance and ease of use.

These and other features, aspects and advantages of the present invention will become understood with reference to the following description, appended claims and accompanying figures.

### BRIEF DESCRIPTION OF THE DRAWINGS

FIG. 1 shows a functional block diagram of an example network implementing an embodiment of the present invention.

FIG. 2 shows a functional block diagram of a framework system for determining and pre-processing potential user queries related to content stored in a home network, according to an embodiment of the present invention.

FIG. 3 shows a flowchart of an embodiment of the steps implemented in a framework system for determining and pre-processing potential user queries related to content stored in a home network, according to an embodiment of the present invention.

### DETAILED DESCRIPTION OF THE INVENTION

The present invention provides a framework for identifying and pre-processing potential user queries based on the knowledge of the various types of content in a local network, such as a home network, enterprise network, etc. The content can comprise content of interest to the user. Once identified, the potential user queries are resolved even before a user expresses interest in them. The query results can be accessed locally by the user when desired.

In one implementation, query pre-processing according to the present invention includes forming a query based on metadata and framing it into a format that can be searched by an external source, such as a search engine on the Internet. For example, metadata can be <Artist: Sting>, based on which a query for a search engine can be framed as “artist sting.” Further, resolving the query involves a process by which results for the query is obtained from the source, before actual user request for information related to the content stored in the network. In this example, this involves obtaining the search results for the query “artist sting.”

Accordingly, the framework identifies, pre-processes and resolves potential user queries even before the user asks for them, such that it becomes possible to respond to many user requests (actual queries) very efficiently. Because desired results are pre-fetched and stored locally, the results can be quickly accessed when needed, compared to accessing the Internet to obtain them when the user asks for them.

Preferably, the framework identifies many potential queries that a home user may be interested in, and can resolve such queries even before the user expresses interest to do so. Further, for example, in a device such as media player that implements such a framework, there is essentially no restriction on the sources accessed for information. The metadata can be obtained locally or from external sources. Further, information of potential interest can be obtained from various sources. For example, the metadata information <Artist:Sting> can be composed as an Internet search engine query or it can be composed specifically for a music website.

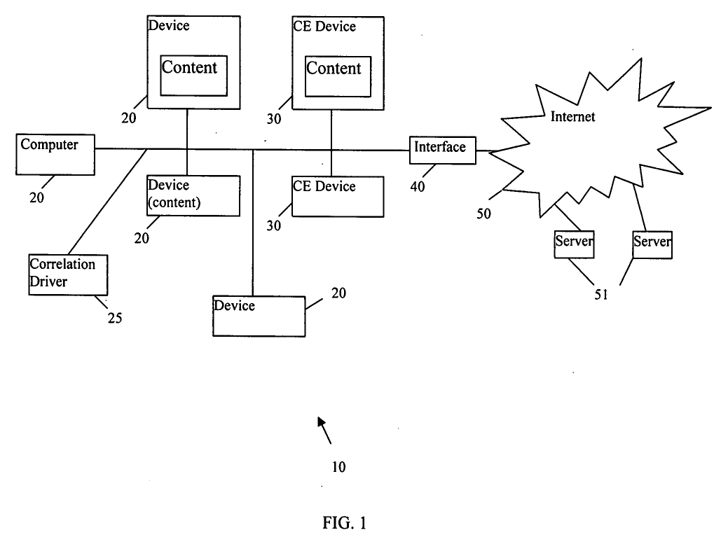

FIG. 1 shows a functional architecture of an example network 10 including a local network (e.g., a home network), embodying a framework according to the present invention. The network 10 comprises devices 20 which may include content, CE devices 30 (e.g., a TV, a VCR, a STB, a cell phone, a PDA, etc.) which may include content, and an interface 40 that connects the network 10 to an external network 50 (e.g., another local network, the Internet, etc.). The external network is connected to one or more servers 51. Though the devices 20 and 30 are shown separately, a single physical device can include one or more logical devices.

The devices 20 and 30, respectively, can be part of an IP-based network and therefore can communicate with each other. In the example described herein, the UPnP protocol is utilized by the network 10. However, those skilled in the art will recognize that the present invention is useful with other network communication protocols (e.g., Bluetooth, Jini, HAVi, IEEE 1394, etc.). The network 10 can be a wired network, a wireless network, or a combination thereof.

Said framework can be implemented as a logical module on any of the devices 20 and 30 in FIG. 1. The different types of content stored in the home network are identified. Then, metadata information for the identified content is obtained from sources including the Internet 50. In one case, Internet seed sources (e.g., CDDB, allmusic.com, etc.) and search engines (e.g., Google, Yahoo, etc.) are used to find the metadata information available for a particular type of content. Then, potential user queries are determined based on metadata for the content stored/accessed in the home network 10. The queries are resolved by searching on the Internet. As such, content of potential interest to the user is identified based on user activity in the network. Such user activity in a network includes, for example, the actions the user performs on the devices in the network, such as watching a particular movie, listening to a piece of music, browsing a webpage, etc.

In one example, a music album of the artist “Sting” is available in the home network 10 and the available metadata information includes artist, album, title and genre of the music. Given this information, an appropriate Internet website (e.g., allmusic.com) is accessed to find other information available about a music album in general and that particular music album by “Sting.” This allows discovery of additional information such as, “release date for the album,” “biography of Sting,” “lyrics for song X in the album” that are available. Based on this information, general queries (e.g., artist biography, release date of album, etc.) and specific queries (e.g., Sting's biography, etc.) are formed to extract additional information from additional (e.g., not music specific) sources such as search engines. The extracted additional information is stored locally in the network for efficient access and speed.

The queries are optionally customized based on contextual information, such as the user's history/preferences, etc. For example, if a particular user has previously requested the age of an artist (a request which the framework has never been able to guess as a potential user query), then the framework ensures that such information is searched and made available in case the user desires it in the future.

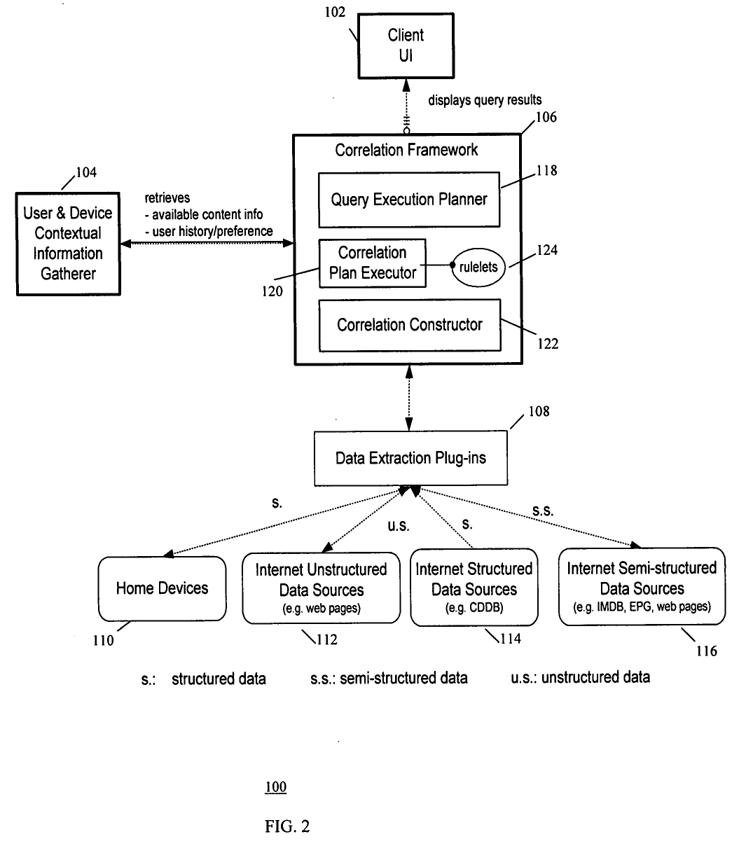

FIG. 2 shows an example framework system 100 according to an embodiment of the present invention. The framework 100 identifies and resolves potential user queries related to content stored in a home network (e.g., devices 20 and 30 of FIG. 1). The framework 100 utilizes the following components: a client User Interface (UI) 102, a User & Device Contextual Information Gatherer (CIG) 104, A Correlation Framework (CF) 106, Data Extraction Plug-Ins 108 providing data extraction techniques, Home Devices 110 (e.g., devices 20, 30 in FIG. 1), Internet Unstructured Data Sources (e.g., web pages) 112, Internet Structured Data Sources (e.g., CDDB) 114 and Internet Semi-Structured Data Sources (e.g., IMDB, EPG) 116.

In the example herein, unstructured data refers to a data segment (e.g., free text data segment, or marked up data segment) whose semantics cannot be analyzed (e.g., Google search ‘pope’ or <other>pope</other>). Structured data refers to XML data with tags that define closely the semantics of small sections of free-form data (e.g., CDs song information <artist>Sting</artist>). Semi-structured data refers to data (such as XML) with tags that define part of the free-form data, but do not describe the semantics of significant sections of the data (e.g., EPG data sections <review> . . . </review>). Web pages are included in both unstructured and semi-structured sources. Most web pages are unstructured (e.g., most web pages with free descriptive text), but some web pages are semi-structured (e.g., those with content from a database).

The CF 106 includes a Query Execution Planner (QEP) 118, a Correlation Plan Executor (CPE) 120, a Correlation Constructor (CC) 122, and Rulelets 124. The CIG 104 and the data extraction plug-ins 108 obtain local content and Internet data for the CF 106. Potential user queries are formed and resolved by the CF 106, and the query results are locally stored and presented to the user when requested.

Specifically, the CIG 104 gathers information about the user, such as current user and device activity, content stored on devices 110, user history, preferences, etc.

The QEP 118 constructs a plan for forming and resolving potential queries, based on information gathered by the CIG 104. The plan essentially describes the steps to execute in order to identify the potential information of interest to the user, and to form one or more queries to search for that information.

The CPE 120 executes this plan using the Rulelets 124 to perform the individual steps in the plan. The Rulelets 124 comprise specialized processes that execute a specific task (e.g., extracting metadata information for a music album, etc.). The Ruelets 124 invoke the data extraction plug-ins 108 for obtaining information from external sources. The data extraction plug-ins 108 extract the requested data from appropriate sources, including the local devices/media repository and the Internet (via Internet search engines such as Google, Yahoo, etc., and seed sources such as CDDB.org, allmusic.com). For example, results from a search engine (e.g., Google) can be obtained from a search engine plug-in 108. Whereas, CDs by Sting can be obtained from an online music store through a plug-in 108 designed to work with that music store site.

The CC 122 stores the search results and identifies correlations amongst them and the locally available data for presentation to the user via the client UI 102 when the user requests such information. In this example, the client UI 102 further provides interfaces for the user to access local content and any related Internet data that the CF 106 identifies and provides to the CC 122.

The modules 104, 106 and 108 in FIG. 2 can be implemented as stand alone modules in the network 10 (FIG. 1). Further, two or more of the modules 104, 106 and 108 can be implemented in one device in the network 10 such as a correlation driver device 25, or in a device 20, a CE device 30, a home device 110. The GUI 102 can be implemented on a device in the network 10 capable of displaying information, such as a CE device 30. The elements 112, 114, 116 reside on the Internet.

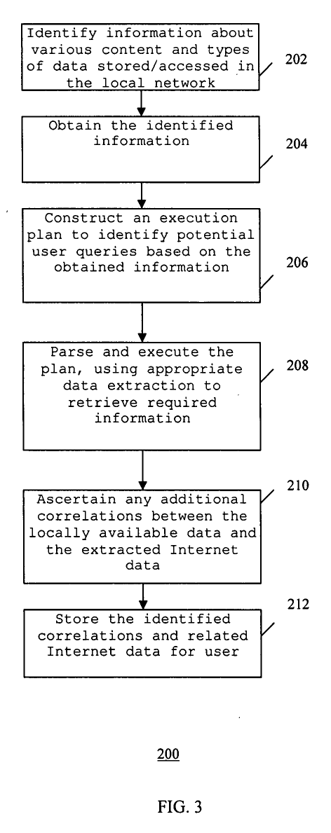

FIG. 3 shows an example process 200 for determining potential user queries and resolving the queries, according to the framework system 100, which includes the steps of:
Step 202: The CIG 104 identifies information about various content and types of data stored/accessed in the home network (e.g., music albums, movie DVD and photo album, etc.). The CIG 104 may use a local data extraction plug-in 108 to identify the content stored in the local network (e.g., the home network).
Step 204: The CF 106 obtains said identified information from the CIG 104.
Step 206: The QEP 118 constructs an execution plan to identify potential user queries, based on the obtained information.
Step 208: The CPE 120 parses and executes the plan by invoking appropriate Rulelets 124 to execute each of the steps in the plan. The Rulelets 124 selectively execute the data extraction plug-ins 108 to retrieve required information from external sources. The required information depends on the query, plan, etc. Some examples include: lyrics for all songs in a music album, biography of an artist, discography of a band, release date of an album, etc.
Step 210: Once the plan is executed, the CC 122 ascertains any additional correlations between locally available data and the data extracted from external sources. In one example, given albums X and Y which are available in the home network, the QEP 118 and CPE 120 identify the “release date” for the albums from the Internet 50 as a potential data of interest to the user. The example release date for both the albums is “2000”. Then, the CC 122 identifies this correlation between the albums (i.e., both of the albums are released in the same year), and aids in creating a list of albums released in the year 2000.
Step 212: The identified correlations and related Internet data are stored locally by the CF 106 and are available for the user to access using e.g. a home device such as a CE device.

The identified correlations can comprise the correlations in step 210, or others, depending on the available local and extracted related data. As such, building over the example in step 210, if the artist of both albums X and Y are the same, the stored correlations/information is used later as follows: A user interface displays the release date of an album alongside other metadata information, when the user accesses the album. The user interface also displays (and allows users to browse) the additional correlations identified, such as the different kinds of virtual album groupings that the framework created.

A framework according to the present invention does not restrict the user to choose from a limited/standard list of related/metadata information. Rather, the framework identifies additional information that the user would likely be interested to access, then extracts and stores such data for the user to efficiently use when desired. Additional information can be made accessible by adding new plans and new plug-ins. Thereby, the framework allows the user to access several types of information efficiently, without the user having to request the information.

The framework further enables a user to utilize a CE device, such as a TV, for accessing information using a small number of keys without a keyboard. As discussed herein (e.g., steps 202-212 above), the Internet data is made available to the user based on resolution of the potential queries that are related to the home network content. Further, the framework allows the users to obtain information from an external network (e.g., the Internet) with minimum involvement in query construction. The framework suggests information based on query context to augment user experience of using CE devices with additional data. Accordingly, the power of the Internet is delivered to consumers that use CE devices in an efficient manner in terms of performance and ease of use.

While the example embodiments herein are related to media content, those skilled in the art will recognize a framework according to the present invention is also useful with, and can be applied to, several other kinds of data such as sports program, news clippings, etc.

As is known to those skilled in the art, the aforementioned example architectures described above, according to the present invention, can be implemented in many ways, such as program instructions for execution by a processor, as logic circuits, as an application specific integrated circuit, as firmware, etc. The present invention has been described in considerable detail with reference to certain preferred versions thereof; however, other versions are possible. Therefore, the spirit and scope of the appended claims should not be limited to the description of the preferred versions contained herein.

What is claimed is:

1. A method of searching for information related to content stored in a network, comprising the steps of:
determining one or more potential user queries for information related to the content stored in the network; and
resolving the queries by searching available sources including one or more external sources, before explicit user request for information related to the content stored in the network.

2. The method of claim 1 wherein:
the network comprises a local network; and
the step of determining said potential user queries further includes determining potential queries for information related to content of interest to the user in the local network.

3. The method of claim 2 further comprising the steps of:
gathering metadata for various types of local content in the local network;
wherein the step of determining said potential user queries further includes determining potential queries based on the metadata.

4. The method of claim 2 further including the steps of constructing queries, wherein the step of resolving the queries further includes pre-processing the queries and obtaining the results before actual user request for information related to the content stored in the local network.

5. The method of claim 4 wherein the step of pre-processing said potential user queries further includes searching the available sources based on the queries, even before the user expresses interest in resolving the queries.

6. The method of claim 5 further including the steps of locally storing the search results in a local store.

7. The method of claim 6 further including the steps of presenting the search results to the user from the local store.

8. The method of claim 2 further comprising the steps of:
the user using a device in the local network to access the network; and
providing search results to the user on that device based on the resolved queries.

9. The method of claim 8 wherein the device in the local network comprises a CE device.

10. The method of claim 2 wherein the available sources include sources external to the local network.

11. The method of claim 10 wherein the sources include the Internet.

12. The method of claim 1 wherein the step of determining said potential user queries further includes:
identifying content of potential interest to the user based on user activity in the network; and
determining potential queries for information related to said content of interest to the user.

13. The method of claim 11 wherein the step of resolving the queries further includes searching the available sources based on the queries, even before the user expresses interest in resolving the queries.

14. The method of claim 12 wherein the local network comprises a home network and the available sources include one or more external networks.

15. The method of claim 7 wherein the step of presenting the search results further includes suggesting information based on user context.

16. The method of claim 15 wherein the step of determining said potential user queries further includes constructing queries for information related to content of interest to the user in the local network by requiring minimum user involvement in query construction.

17. A consumer electronics device capable of being connected to a network, comprising:
a contextual information gatherer that is configured to identify information related to content stored in the network;
a query execution planner that is configured to determine one or more potential user queries related to the identified information; and
a query resolver that is configured to resolve the queries by searching available sources including one or more external sources, before actual user request for information related to the content stored in the network.

18. The consumer electronics device of claim 17 wherein the query resolver includes a data extractor that is configured to extract data related to said identified information from available sources.

19. The consumer electronics device of claim 18 wherein:
the network comprises a local network; and
the query execution planner is further configured to determine potential user queries for information related to content in the local network that is of interest to the user.

20. The consumer electronics device of claim 19 wherein:
the contextual information gatherer is further configured to gather metadata for various types of local content in the local network; and
the query execution planner is further configured to determine said potential user queries based on the metadata.

21. The consumer electronics device of claim 19 wherein the query resolver is further configured to resolve the queries before actual user request for information related to the content stored in the local network.

22. The consumer electronics device of claim 21 wherein the query resolver is further configured to invoke the data extractor to search the available sources based on the queries, even before the user expresses interest in resolving the queries.

23. The consumer electronics device of claim 19 wherein:
the query execution planner is further configured to form potential user queries based on the identified information; and
the data extractor is further configured to extract data related to said identified information from the available sources based on the queries.

24. The consumer electronics device of claim 23 further comprising a correlation constructor that is configured to determine correlations by finding data in the extracted data that is most relevant to said identified information.

25. The consumer electronics device of claim 24 wherein the correlation constructor is further configured to analyze the extracted data to find correlations between the extracted data and the identified information and the context information.

26. The consumer electronics device of claim 29 wherein:
the contextual information gatherer is further configured to gather further context information related to the identified information of interest to the user; and
the query execution planner is further configured to form potential user queries based on the context information and said identified information, and construct a plan to resolve the queries.

27. The consumer electronics device of claim 26 further comprising a plan executor that is configured to execute the plan by controlling the data extractor to extract data related to said identified information from said available sources.

28. The consumer electronics device of claim 27 wherein the plan identifies Internet sources and the data extractor is further configured to extract data from the identified Internet sources.

29. The consumer electronics device of claim 19 wherein the local network comprises a home network including consumer electronic devices.

30. The consumer electronics device of claim 19 wherein the available sources comprise the Internet.

31. The consumer electronics device of claim 27 wherein the plan executor is configured to parse and execute said plan and selectively control data extractor to retrieve information.

32. The consumer electronics device of claim 27 wherein the plan executor is configured to parse and execute said plan and selectively control data extractor to retrieve information from one or more of: the local network and the external source.

33. The consumer electronics device of claim 27 further comprising a storage module that is configured to store the search results in a local storage device for later access by the user.

34. The consumer electronics device of claim 33 further comprising a user interface module that is configured to present the search results to the user from the local storage device.

35. The consumer electronics device of claim 19 wherein the contextual information gatherer is further configured to identify content of potential interest to the user based on user activity in the network.

36. A query system for searching for information related to content stored in a network, comprising:
a contextual information gatherer that is configured to identify information related to content stored in the network;
a query execution planner that is configured to determine one or more potential user queries related the identified information; and
a query resolver in a device in the network, that is configured to resolve the queries by searching available sources including one or more external sources, before actual user request for information related to the content stored in the network.

37. The system of claim 36 wherein the query resolver includes a data extractor that is configured to extract data related to said identified information from available sources.

38. The system of claim 37 wherein:
the network comprises a local network; and
the query execution planner is further configured to determine potential user queries for information related to content in the local network that is of interest to the user.

39. The system of claim 38 wherein:
the contextual information gatherer is further configured to gather metadata for various types of local content in the local network; and
the query execution planner is further configured to determine said potential user queries based on the metadata.

40. The system of claim 38 wherein the query resolver is further configured to resolve the queries before actual user request for information related to the content stored in the local network.

41. The system of claim 40 wherein the query resolver is further configured to invoke the data extractor to search the available sources based on the queries, even before the user expresses interest in resolving the queries.

42. The system of claim 38 wherein:
the query execution planner is further configured to form potential user queries based on the identified information; and
the data extractor is further configured to extract data related to said identified information from the available sources based on the queries.

43. The system of claim 42 further comprising a correlation constructor that is configured to determine correlations by finding data in the extracted data that is most relevant to said identified information.

44. The system of claim 43 wherein the correlation constructor is further configured to analyze the extracted data to find correlations between the extracted data and the identified information and the context information.

45. The system of claim 38 wherein:
the contextual information gatherer is further configured to gather further context information related to the identified information of interest to the user; and
the query execution planner is further configured to form potential user queries based on the context information and said identified information and to construct a plan to resolve the queries.

46. The system of claim 45 further comprising a plan executor that is configured to execute the plan by controlling the data extractor to extract data related to said identified information from said available sources.

47. The system of claim 46 wherein the plan identifies Internet sources and the data extractor is further configured to extract data from the identified Internet sources.

48. The system of claim 38 wherein the local network comprises a home network including consumer electronic devices.

49. The system of claim 38 wherein the available sources comprise the Internet.

50. The system of claim 46 wherein the plan executor is configured to parse and execute said plan and selectively control data extractor to retrieve information.

51. The system of claim 46 wherein the plan executor is configured to parse and execute said plan and selectively control data extractor to retrieve information from one or more of: the local network and the external source.

52. The system of claim 46 further comprising a storage module that is configured to store the search results in a local storage device for later access by the user.

53. The system of claim 52 further comprising a user interface module that is configured to present the search results to the user from the local storage device.

54. The system of claim 38 wherein the contextual information gatherer is further configured to identify content of potential interest to the user based on user activity in the network.
